(19) United States
(12) Patent Application Publication
(10) Pub. No.: US 2024/0200264 A1
(43) Pub. Date: Jun. 20, 2024

(54) PLANT-BASED LEATHER SUBSTITUTE MATERIAL

(71) Applicant: Gestion Dryad Inc., Bromont (CA)

(72) Inventors: Francois SIMARD, Bromont (CA); Martin FILTEAU, Mont St-Hilaire (CA); Ahmad IBRAHIM, St-Hyacinthe (CA)

(21) Appl. No.: 18/554,449

(22) PCT Filed: Apr. 7, 2022
(86) PCT No.: PCT/CA2022/050537

§ 371 Date: Oct. 6, 2023

Related U.S. Application Data
(60) Provisional application No. 63/171,775, filed on Apr. 7, 2021.

(51) Int. Cl. D06N 3/04; A41D 13/015; C08L 91/00; D06N 3/00

(52) U.S. Cl. CPC D06N 3/04; A41D 13/015; C08L 91/00; D06N 3/0006; D06N 3/0009; D06N 3/0011; D06N 3/0015; D06N 3/0088; A41D 2500/10; A41D 2500/20; A41D 2500/30; C08L 2205/025; C08L 2205/03; C08L 2205/06; C08L 2207/322; D06N 2201/04; D06N 2203/022; D06N 2209/105; D06N 2209/123; D06N 2209/128; D06N 2211/10; D06N 2211/28

(57) ABSTRACT

The technology relates to plant-based materials that may be used as a substitute for animal leather. In some embodiments, the plant-based leather substitute material has properties and performances similar or equivalent to the properties and performances of animal leather. The plant-based leather substitute material includes a textile substrate, a plant-based resin, and a non-vulcanized natural rubber. The plant-based resin and the non-vulcanized natural rubber, once mixed, are provided on the textile substrate. The plant-based resin may made from castor seed oil. The plant-based leather substitute material has water vapor-permeability, water-impermeability properties, and abrasion resistance properties similar or equivalent to the water vapor-permeability, water-impermeability properties, and abrasion resistance properties of animal leather but does not contain any animal products or derivatives thereof.

### TECHNICAL FIELD

The technical field generally relates to textile and fabric technology, and more particularly relates to plant-based materials that may be used as an alternative to animal leather.

### BACKGROUND

Animal leather is a material commonly used in a broad variety of applications such as, to name a few, clothing, furniture, and car interior. The popularity of animal leather can notably be attributed to some of its properties that may include, for example, flexibility, abrasion resistance, and breathability.

However, animal leather production is among the most polluting industries. Indeed, animal leather production is associated with environmental hazards and health issues for people working in this industry.

There remains a need in the art for a material having properties similar to animal leather but that would be at least less detrimental to the environment or workers of the textile industry.

### SUMMARY

The present techniques relate to plant-based materials that may be used as a substitute to animal leather. In some embodiments, the plant-based leather substitute material has properties and performances similar or equivalent to the properties and performances of animal leather.

In accordance with one aspect, there is provided a plant-based leather substitute material. The plant-based leather substitute material includes a textile substrate, a plant-based resin, and a non-vulcanized natural rubber. The plant-based resin and the non-vulcanized natural rubber, once mixed, are provided on the textile substrate. The plant-based resin may made from castor seed oil alone or may alternatively include castor seed oil. The plant-based leather substitute material has water vapor-permeability properties and water-impermeability properties similar or equivalent to the water vapor-permeability properties and water-impermeability properties of animal leather but does not contain any animal products or derivatives thereof.

In some embodiments, the plant-based resin and the non-vulcanized natural rubber may be mixed to form a homogeneous mixture, and the homogeneous mixture may be dispensed on the textile substrate to form a layer extending over the textile substrate, the layer including both the plant-based resin and the non-vulcanized natural rubber material. In some embodiments, the overall thickness of the layer may be included in a range extending from about 0.1 mm to about 1.5 mm. The homogeneous mixture may include between about 99% and about 60% of the plant-based resin and between about 1% and about 40% of the non-vulcanized natural rubber. In some embodiments, the homogeneous mixture may include about 90% of the plant-based resin and about 10% of the non-vulcanized natural rubber.

In accordance with one aspect, there is provided a plant-based leather substitute material, the plant-based leather substitute material including:
a textile substrate; and
a plant-based resin and a non-vulcanized natural rubber, the plant-based resin including at least a castor seed oil, the plant-based resin and the non-vulcanized natural rubber being mixed together and disposed on the textile substrate;
   wherein the textile substrate, the plant-based resin and the non-vulcanized natural rubber are each free of animal products and derivatives thereof, and the textile substrate, the plant-based resin and the non-vulcanized natural rubber collectively have water vapor-permeability properties and water-impermeability properties equivalent to water vapor-permeability properties and water-impermeability properties of animal leather.

In some embodiments, wherein the plant-based resin and the non-vulcanized natural rubber form a homogeneous mixture, the homogeneous mixture being dispensed on the textile substrate to form a layer of substantially uniform composition extending over the textile substrate.

In some embodiments, the homogeneous mixture includes between about 99% and about 60% of the plant-based resin and between about 1% and about 40% of the non-vulcanized natural rubber.

In some embodiments, the homogeneous mixture includes about 90% of the plant-based resin and about 10% of the non-vulcanized natural rubber.

In some embodiments, the textile substrate, the plant-based resin and the non-vulcanized natural rubber collectively have an overall thickness of included in a range extending from about 0.1 mm to about 1.5 mm.

In some embodiments, the non-vulcanized natural rubber includes a plasticizer.

In some embodiments, the plasticizer is a plant-based plasticizer.

In some embodiments, the plasticizer is free of animal products and derivatives thereof.

In some embodiments, the plasticizer includes an epoxidized soya bean oil.

In some embodiments, the plant-based resin and the non-vulcanized natural rubber collectively form a layer laminated to the textile substrate.

In some embodiments, the textile substrate is made from a natural fiber.

In some embodiments, the textile substrate is a viscose textile substrate.

In some embodiments, the plant-based leather substitute material is a woven, a knitted or a non-woven material.

In accordance with one aspect, there is provided an item of clothing including at least a portion made from a fabric, the fabric being the plant-based leather substitute material as described herein.

In accordance with one aspect, there is provided a protective garment, including:
at least one portion configured to be exposed to an external mechanical force; and
a reinforcement fabric made position in said at least one portion configured to be exposed to the external mechanical force, the reinforcement fabric being made from the plant-based leather substitute material as described herein.

Other features and advantages of the present invention will be better understood upon a reading of embodiments thereof with reference to the appended drawings.

### BRIEF DESCRIPTION OF THE DRAWINGS

FIG. 1 illustrates a plant-based leather substitute material, in accordance with one embodiment.

FIG. 2 illustrates a plant-based leather substitute material, in accordance with one embodiment.

FIG. 3 illustrates a plant-based leather substitute material, in accordance with one embodiment.

FIG. 4 illustrates a plant-based leather substitute material, in accordance with one embodiment.

FIG. 5 illustrates a plant-based leather substitute material, in accordance with one embodiment.

FIG. 6 illustrates an item of clothing including a plant-based leather substitute material, in accordance with one embodiment.

### DETAILED DESCRIPTION

In the following description, similar features in the drawings have been given similar reference numerals, and, to not unduly encumber the figures, some elements may not be indicated on some figures if they were already identified in one or more preceding figures. It should also be understood herein that the elements of the drawings are not necessarily depicted to scale, since emphasis is placed upon clearly illustrating the elements and structures of the present embodiments.

The terms “a”, “an” and “one” are defined herein to mean “at least one”, that is, these terms do not exclude a plural number of elements, unless stated otherwise. It should also be noted that terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

It will be appreciated that positional descriptors indicating the position or orientation of one element with respect to another element are used herein for ease and clarity of description and should, unless otherwise indicated, be taken in the context of the figures and should not be considered limiting. It will be understood that spatially relative terms (e.g., “outward” and “inward”, “frontward” and “rearward”, “front” and “rear”, “left” and “right”, “top” and “bottom” and “outer” and “inner”) are intended to encompass different positions and orientations in use or operation of the present embodiments, in addition to the positions and orientations exemplified in the figures.

In current disclosure, the expression “bio-based polymers” refers to organic macromolecules derived from biological resources. Of note, bio-based polymers are typically man-made polymers, and so may be referred to as “artificial”, “synthetic” or “manufactured” polymers.

The expression “non-vulcanized”, synonyms and derivatives thereof will be used throughout the description. The expression “vulcanized” generally refers to the state of a material after a vulcanization process. An objective of such a process is generally to form permanent bridges between the molecular chains of the natural rubbers, synthetic rubbers, or similar materials, which may help in hardening the same. The vulcanization process typically relies on the formation of cross-links between portions or sections of a polymer chain, which generally results in a change in physical and/or chemical properties such as, to name a few, increased rigidity, enhanced mechanical properties and/or improved electrical properties of the material being vulcanized. Of note, the expression “cross-links” herein refers to the bonds between one polymer chain to one or more other polymer chains. The bonds may be covalent or ionic.

The term “fabric” refers specifically to a woven or knitted material, and more generally to flexible materials comprising a network of natural fibers, artificial fibers or combination thereof. Unless otherwise specified, the description of the fabric is applicable to woven, non-woven, and knitted materials, as well as to other materials that will be later introduced and described.

The term “textile” as used herein is meant to generally refer to an element manufactured from natural or synthetic (i.e., man-made) fibers or filaments or monofilaments. Non-limiting examples of synthetic fibers or filaments include animal leather, polyester, polyamide (e.g., Nylon), aramid or meta-aramid (e.g., Kevlar™, Technora™, Twaron™, Nomex™, Teijinvonex™, Kermel™ and Hecracron™), Zylon™, polyethylene (PE), polytetrafluoroethylene (ePTFE), polyphenylene sulfide (PPS), polyetheretherketone (PEEK), acrylic, modacrylic, polyurethane (e.g., spandex or Lycra™), oleofin fibers, polylactide fibers (ingeo), metallic fibers (e.g., lurex), and milk or casein protein fibers. Non-limiting examples of natural fibers or filaments include wool, silk, cashmere, hemp, flax (linen), cotton, and bamboo fibers. Non-limiting examples of such elements include yarns, threads, and fabrics.

In the current disclosure, the expression “mechanical properties” or the like may include, but are not limited, to fiber strength, elongation, elasticity, abrasion resistance, and modulus of elasticity. Measurements of such mechanical properties may be achieved using techniques known in the art.

The present description generally refers to textile or fabric technology, and more particularly to a plant-based leather substitute material having performances relatively similar or equivalent to animal leather, i.e., properties such, for example, particulate and liquid impermeability, as well as air or vapor permeability.

### General Theoretical Context

Animal leather is globally recognized as an appropriate material for many applications that require mechanical and abrasion resistance, breathability, and/or waterproofness. Properties of animal leather include, to name a few, waterproof properties, resistance to hydrostatic water pressure of about 125 cm (according to the AATCC 127-2018 method), and water vapor transmission capacity about 2250 g/m²-24 h (according to the ASTM E96/E96M method BW procedure). These properties justify the use of animal leather in rain protective garments, furniture, and car interior. Despite its interesting properties, the use of animal leather has several drawbacks for tailors, such as: availability, consistency, price, and the high environmental impact associated with its manufacturing process.

Animal leather comes from a renewable resource but nonetheless has important negative effects on the environment and is now considered as a major cause of pollution. Traditional animal leather processing involves different types of toxic chemicals and typically requires a huge amount of food, pasture, water, and fossil fuels for animal husbandry. The Environment Protection Agency (EPA) has even recognized that pollution of liver stocks as the greatest threat to waterways in the United States.

Animal leather is the skin of an animal that has been transformed or processed. After the death of the animal in a slaughterhouse, the skin is transformed, which may include several steps such as, to name a few: dehydration (most often by salting or drying), cleaning (removing hair, subcutaneous tissue, and the like), tanning (transforming the skin into a rot-proof material), wrought (providing solidity, flexibility and/or base color to the leather), and finishing (providing the color and the final rendering). Each of these steps contributes to polluting the planet.

For example, traditional tanning processes rely on the use of chromium sulfate. This material consumes a lot of water and its use may require the consumption of about 45 to 60 million liters of water per day. The chemicals used in this process are also relatively toxic. Effluents from tanneries are a major source of pollution of water bodies in many regions. Almost all leather processing waste contains chromium, a relatively dangerous chemical. Besides chromium, there are various other pollutants that are generated by tanneries, including proteins, hair, salt, lime sludge, sulfides, and acids. Approximately 15,000 gallons of water are wasted by chrome tanning facilities, which creates almost 2,200 pounds of solid waste for every ton of hides. Approximately 800,000 tons of chromium waste are generated by tanning leather. The ecological impacts of the tanning process may exacerbate water scarcity situations and may render the access to clean water difficult.

Recently, “vegetal leathers” have been introduced. However, such vegetal leathers typically refer to animal leather having been treated with a plant-based product instead of chromium or other traditional treatment material. However, the dyeing process of the vegetal leathers and the greenhouse gas generated by the animal husbandry both remain important causes pollution.

The danger linked to animal leather production is not limited to the workers and their environment. For example, a person wearing animal leather may be affected by the poisons contained in animal leather, such as, for example, hexavalent chromium, which may be associated with skin problems. In addition, several medical problems may arise due to the contamination groundwater near tanneries and its surrounding areas. Recent studies have shown that the probability of being diagnosed with a tumor may increase by about 20% to about 50% for people working in tanneries.

Animal leather production may also be linked to sustainability issues, especially as a by-product of the meat industry. However, several farms are dedicated to the production of animal leather. In such farms, the animals are confined in relatively small spaces to avoid damaging the skin of the animal, which would reduce the value of the animal leather. Intensive livestock farming may also be associated with deforestation, overuse of water and land, and/or toxic gas emissions. The “Higg Materials Sustainability Index” (Higg MSI) is an example of indices that may be used to evaluate the environmental impact of materials. The Higg MSI of typical animal leathers is about 159, which is relatively high, in comparison with the Higg MSI of polyester (about 44) and cotton (about 98), due to its strong contribution to global warming and pollution.

Alternatives to animal leather have been known for several decades. However, these alternatives typically rely on petroleum-based materials or products. An example of such alternatives is leatherette, a product made from polyurethane or polyvinyl chloride and which may contain fluorinated components (e.g., polytetrafluoroethylene) or that may be made of polymers (e.g., polyurethane or polyester). Leatherette is typically used as an outer layer in clothes, and so leatherette is generally provided as a relatively thick fabric offering little or even no moisture vapor transmission. It should be noted that the environmental impacts of leatherette are also non-negligible, as it is a petroleum-based material which may not be biodegradable, and so generates plastic particles in the oceans.

More recently, plant-based leather alternatives were introduced to mitigate the challenges associated with animal leather production. Examples of such products include eucalyptus leather, pineapple leather, leather from fungus or cork. Other alternatives rely on the combination of natural materials such as linen, cotton mixed with corn and soybeans with vegetable oils under high pressure to create a planted-based or vegetal leather having characteristics resembling the ones of animal leather. Despite the advancements made to find an eco-friendly leather not made from animals, none of these products can replace animal leather, because it remains challenging to attain the overall or global performances of animal leather using plant-based leather.

The present technology generally relates to a plant-based leather substitute material that may be used as a waterproof breathable barrier fabric. Such a waterproof breathable barrier fabric may be used in garments, furniture, furniture coverings, automotive interiors, and many other applications.

### Plant-Based Leather Substitute Material

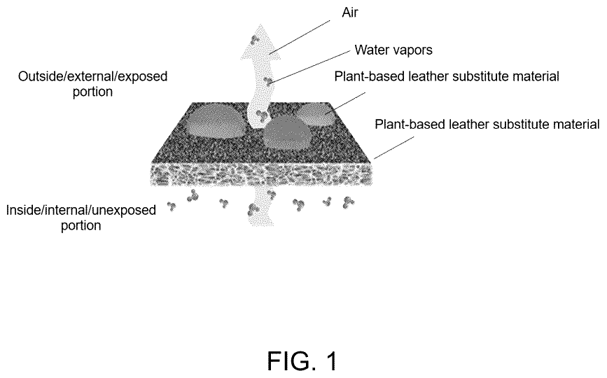

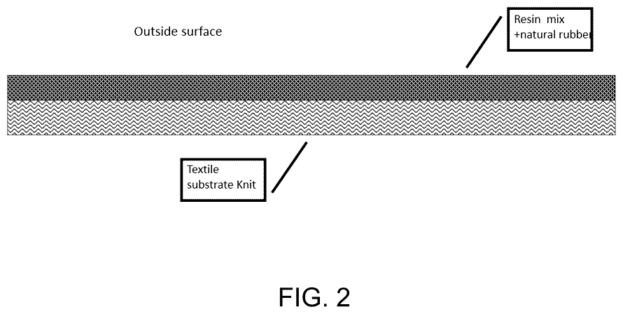

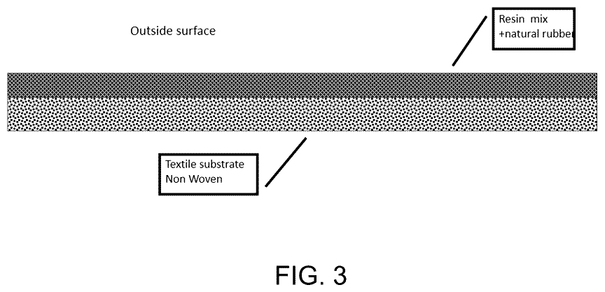

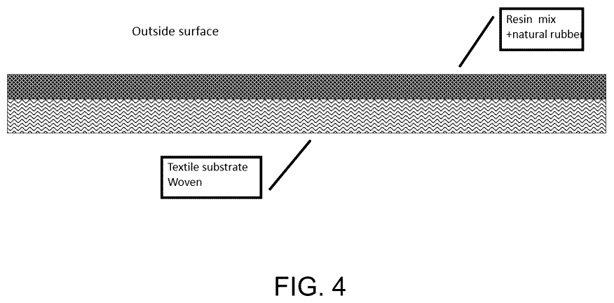

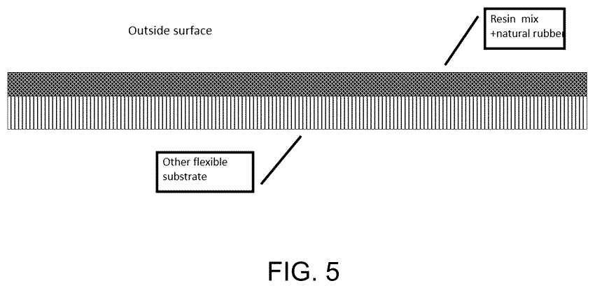

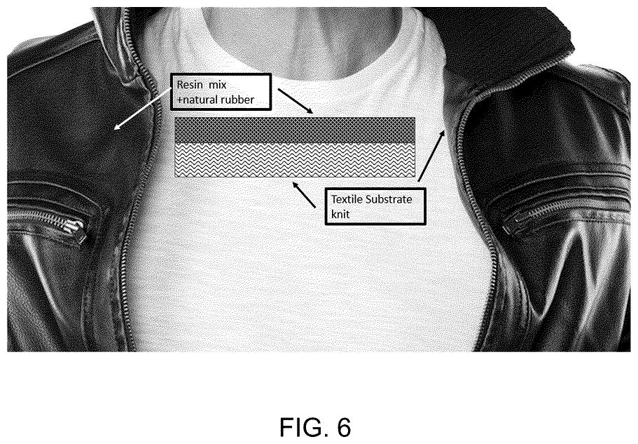

Referring to FIGS. 1 to 6, an embodiment of a plant-based leather substitute material is illustrated. Of note, the plant-based leather substitute material may be qualified as “vegan”, i.e., containing no traces of any animal products or derivatives thereof.

The plant-based leather substitute material may include a textile substrate, for example a textile substrate made from a natural fiber. In some embodiments, the textile substrate may be a viscose textile substrate and may be produced from plant fibers combined with polylactic acid (PLA) membrane that may be made from corn.

The plant-based leather substitute material includes a plant-based resin, such as castor oil. Castor oil is vegetable oil that is obtained by pressing castor beans or castor seeds Castor beans or seeds are also known as “Ricinus”, “Ricinus communis” or “castor oil plant”. In some embodiments, the plant-based resin is exclusively made from castor oil.

The plant-based leather substitute material includes a non-vulcanized natural rubber. It should be noted that adding the non-vulcanized natural rubber to the plant-based resin may allow obtaining a degree of flexibility to the plant-based leather substitute material that would not be achievable using the plant-based resin alone. Of note, vulcanized natural rubber materials are generally used in industrial applications. In the present technology, the natural rubber is used as a thermoplastic material rather than a thermoset material and is non-vulcanized. Being non-vulcanized, the natural rubber remains relatively sensitive to heat and may be relatively sticky, which may justify limiting the concentration (i.e., percentage) of the non-vulcanized natural rubber in the plant-based leather substitute material. In small concentration (e.g., from about 10% or about 15%), the non-vulcanized natural rubber may act as a plasticizer and may help in softening plant-based resin.

The plant-based resin and the non-vulcanized natural rubber, once mixed, may be provided on the textile substrate.

In some embodiments, the plant-based resin and the non-vulcanized natural rubber may be mixed to form a homogeneous mixture, and the homogeneous mixture may be dispensed on the textile substrate to form a layer extending over the textile substrate, the layer including both the plant-based resin and the non-vulcanized material. The homogeneous mixture may include between about 95% and about 70% of the plant-based resin and between about 5% and about 30% of the non-vulcanized natural rubber. In some embodiments, the homogeneous mixture may include about 90% of the plant-based resin and about 10% of the non-vulcanized natural rubber. In some embodiments, the homogeneous mixture may include between about 99% and about 60% of the plant-based resin and between about 1% and about 40% of the non-vulcanized natural rubber.

In some embodiments, the layer including the plant-based resin and the non-vulcanized natural rubber may be laminated to the textile substrate.

The plant-based leather substitute material has water vapor-permeability properties and water-impermeability properties similar or equivalent to the water vapor-permeability properties and water-impermeability properties of animal leather but does not contain any animal products and/or only traces or relatively small amounts of petroleum-based products. In some embodiments, the plant-based leather substitute material reproduces or closely matches the behavior of animal leather. For example, the water resistance, the moisture vapor permeability, the resistance to cold flex, and the suppleness of the plant-based leather substitute material may be similar to the ones of animal leather.

In some embodiments, the plant-based leather substitute material may be a woven, a knitted, or a non-woven material.

In some embodiments, the overall visual aspect of the plant-based leather substitute material is similar to the appearance of animal leather.

In some embodiments, additives, such as, for example, dyes, particles, and/or nanoparticles may be added to the plant-based leather substitute material.

As it has been previously mentioned, the plant-based leather substitute material has mechanical properties, water vapor-permeable properties, liquid/water-impermeable properties, and/or many other properties similar to the properties of animal leather. The mechanical properties may include, for example and without being limitative, flexibility and mechanical resistance to abrasion and puncture. The water vapor-permeability properties may allow the passage of water vapor while blocking water. The combination of the mechanical properties, water vapor-permeable properties, and liquid-impermeable properties optimize both the comfort and the security of the wearer. In some embodiments, the plant-based leather substitute material may meet specific requirements with respect to water vapor permeability. Preferably, the plant-based leather substitute material has an overall water vapor permeability which is high enough so that sufficient water vapor can circulate through. This feature may be useful to provide a degree of comfort and/or cooling to the wearer.

In some embodiments, the plant-based leather substitute material may be cleaned and reused several times without substantially affecting the mechanical properties, water vapor-permeable properties, and/or liquid-impermeable properties.

In some embodiments, the plant-based leather substitute material may be used to manufacture any items of clothing, such as, for example and without being limitative, garments, coats, pants, shirts, shorts, gloves, hats, dresses, skirts, and the like.

In some embodiments, the plant-based leather substitute material may be positioned in areas or portions of a garment exposed to external mechanical forces and that may be potentially wear over time without the presence of a reinforcement fabric. As such, a garment may be equipped with a plurality of fabrics made from the plant-based leather substitute material, each being aligned with a corresponding area of the garment exposed to external mechanical forces. Nonlimitative examples of such areas are cuffs, elbows, and/or knees.

The technology having been described is associated with several benefits. For example, the plant-based leather substitute material may be made from 100% bio-sourced products while offering relatively high abrasion resistance and breathability. Obtaining this combination of advantages without having recourse to animal leather or animal products is also associated with several advantages, from both environmental and ethical points of view. It is this last combination of advantages that has always given animal leather its worldwide popularity. In some embodiments, the plant-based leather substitute material may include only traces or a relatively small amount (e.g., 4% to 5%, or less) of petroleum-based components, and so may be more eco-friendly than existing technologies used as a replacement for animal leather.

### Examples

Now that different embodiments of the technology have been described, some nonlimitative examples will be presented. It should be noted that these examples serve an illustrative purpose only and should therefore not be considered limitative.

According to a first example, there is provided a plant-based flexible material combining a textile substrate laminated to a bio-based polymer. The textile substrate may include natural fibers. The plant-based flexible material generally behaves like animal leather, i.e., the flexible material has at least equal moisture vapor permeability and/or relatively high water-penetration resistance. In some embodiments, the bio-based polymer includes a blend of bio-based polymers, such as, for example, Ricinus communis polymers. Of note, the plant-based flexible material according to the first example eliminates the need to raise and slaughter animals to make clothes, furniture, and/or car interiors. Also, the plant-based flexible material may be produced according to a more ethical process that eliminates cruelty towards animal and also generates less greenhouse gas in comparison with the production of animal leather. In some embodiments, the overall thickness of the plant-based flexible material may be similar to animal leather (i.e., for a given use, the thickness of the animal leather and the plant-based flexible material would be approximately the same). In some embodiments, the overall thickness of the plant-based flexible material may be included in a range extending from about 0.5 mm to about 1.5 mm. In some embodiments, the bio-based polymer is bonded to the textile substrate, such that these two components remain secured one to another throughout the useful life of the product incorporating the plant-based flexible material. It should be noted that the plant-based flexible material may be provided as a sheet having a relatively constant thickness and performances that are substantial uniform. In some embodiments, the plant-based flexible material has mechanical properties (e.g., abrasion resistance) comparable to the mechanical properties of animal leather.

According to a second example, there is provided a plant-based leather including a homogeneous mixture of plant-based resin and non-vulcanized natural rubber. In some embodiments, the plant-based resin includes castor seed oil. In some embodiments, the ratio between the plant-based resin and the non-vulcanized natural rubber about 90:10 (plant-based resin: non-vulcanized rubber). Of note, the addition of non-vulcanized natural (i.e., vegetable) rubber provides enhanced flexibility to the plant-based leather, such that the flexibility of the plant-based least is similar to the flexibility of the animal leather. However, it should be noted that the ratio between the plant-based resin and the non-vulcanized natural rubber has to be selected such that vapor permeability (breathability) properties and/or abrasion-resistance properties of the plant-based leather remain comparable to the ones of animal leather. More particularly, using a higher concentration of non-vulcanized natural rubber may compromise the breathability properties and/or the abrasion-resistance properties of the plant-based leather. It should also be noted that existing technologies generally rely on vulcanized natural rubber, whereas the present techniques rely on non-vulcanized natural rubber.

### Examples of Results

The section below provides examples of results related to embodiments of the plant-based leather substitute material having been previously described. The following section should not be interpreted as being limitative and serves an illustrative purpose only.

Table 1 summarizes the performance of the plant-based leather substitute material having been herein described, in comparison with animal leathers or other vegetal leathers.

TABLE 1
Comparison between the present technology, animal
leather and existing alternatives to animal leather

| | | | | Water |
|---|---|---|---|---|
| | MVT ASTM | Water | | resistance |
| | E96 BW | resistance | Abrasion | after cold |
| Sample Name | (1 d) | (cm) | resistance | flex |
| PU Synthetic | 57 | 39 | — | — |
| Pineapple Leather | 2780 | 18 | — | — |
| Cork Leather | 181 | >1000 | — | — |
| Animal Leather | 2279 | 126 | 1459 | — |
| Cardboard Leather | 2802 | 29 | — | — |
| Stedair Knit | 2995 | >1000 | | |
| Present technology | 3618 | 2210 | 1310 | 2128 |

As illustrated, the plant-based leather substitute material according to the present technology performs similarly to animal leathers, and generally performed better than existing alternatives to animal leather.

Table 2 illustrates additional results obtained with an embodiment of the technology described herein.

TABLE 2
Results obtained with an embodiment of the technology described herein

| | | | | Water | | |
|---|---|---|---|---|---|---|
| | | | | resistance | Rigidity on Kawabata | |
| | MVT ASTM | Water | | after cold | (gf · cm²/cm) | |
| | E96 BW | resistance | Abrasion | flex (10 min, | B. Mean | B. Mean |
| Sample Name | (g/cm² · 24 h) | (cm) | resistance | 10 psi) | Length | Width |
| Pebax 30R51 | 3618 ± | 2210 ± | 1310 | 2128 ± | 0.0986 ± | 0.1003 ± |
| (laminated on | 152 | 48 | | 113 | 0.0069 | 0.0042 |
| cotton) | | | | | | |
| Pebax | 3605 ± | 150 ± | 170 | L | 0.0831 ± | 0.0809 ± |
| 30R51/10% CN | 146 | 13 | | | 0.0004 | 0.002 |
| (not laminated) | | | | | | |
| Pebax | 4023 ± | 99 ± | 38 | L | 0.0776 ± | 0.0889 ± |
| 30R51/20% CN | 402 | 29 | | | 0.0139 | 0.0241 |
| (not laminated) | | | | | | |
| Pebax | 3133 ± | | | | 0.0776 ± | 0.0719 ± |
| 30R51/10% | 194 | | | | 0.0042 | 0.0025 |
| ESBO (not | | | | | | |
| laminated) | | | | | | |
| Pebax | 2902 ± | | | | 0.2192 ± | 0.1830 ± |
| 30R51/10% | 162 | | | | 0.0243 | 0.0091 |
| TPE (not | | | | | | |
| laminated) | | | | | | |

Table 3 illustrates additional results obtained with an embodiment of the technology described herein.

TABLE 3
Comparison between the present technology and existing solutions

| | | | | Water | | |
|---|---|---|---|---|---|---|
| | | | | resistance | Rigidity on Kawabata | |
| | MVT ASTM | Water | | after cold | (gf · cm²/cm) | |
| | E96 BW | resistance | Abrasion | flex (10 min, | B. Mean | B. Mean |
| Sample Name | (g/cm² · 24 h) | (cm) | resistance | 10 psi) | Length | Width |
| Pebax 30R51 | 3618 ± | 2210 ± | 1310 | 2128 ± | 0.0986 ± | 0.1003 ± |
| (laminated on | 152 | 48 | | 113 | 0.0069 | 0.0042 |
| cotton) | | | | | | |
| Desserto ® | 124 ± | 1212 ± | 460 ± | L | | |
| | 5 | 6 | 102 | | | |

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the scope defined in the current description.

1. A plant-based leather substitute material, the plant-based leather substitute material comprising:
a textile substrate; and
a plant-based resin and a non-vulcanized natural rubber, the plant-based resin comprising at least a castor seed oil, the plant-based resin and the non-vulcanized natural rubber being mixed together and disposed on the textile substrate;
wherein the textile substrate, the plant-based resin and the non-vulcanized natural rubber are each free of animal products and derivatives of animal products, and
wherein the textile substrate, the plant-based resin, and the non-vulcanized natural rubber collectively have water vapor-permeability properties and water-impermeability properties equivalent to water vapor-permeability properties and water-impermeability properties of animal leather.

2. The plant-based leather substitute material of claim 1, wherein the plant-based resin and the non-vulcanized natural rubber form a homogeneous layer of substantially uniform composition extending over the textile substrate.

3. The plant-based leather substitute material of claim 2, wherein the homogeneous layer comprises between about 99% and about 60% of the plant-based resin and between about 1% and about 40% of the non-vulcanized natural rubber.

4. The plant-based leather substitute material of claim 2, wherein the homogeneous layer comprises about 90% of the plant-based resin and about 10% of the non-vulcanized natural rubber.

5. The plant-based leather substitute material of claim 1, wherein the textile substrate, the plant-based resin, and the non-vulcanized natural rubber collectively have an overall thickness of about 0.1 mm to about 1.5 mm.

6. The plant-based leather substitute material of claim 1, wherein the non-vulcanized natural rubber comprises a plasticizer.

7. The plant-based leather substitute material of claim 6, wherein the plasticizer is a plant-based plasticizer.

8. The plant-based leather substitute material of claim 6, wherein the plasticizer is free of animal products and derivatives of animal products.

9. The plant-based leather substitute material of claim 6, wherein the plasticizer comprises an epoxidized soya bean oil.

10. The plant-based leather substitute material of claim 1, wherein the plant-based resin and the non-vulcanized natural rubber collectively form a layer laminated to the textile substrate.

11. The plant-based leather substitute material of claim 1, wherein the textile substrate is made from comprises a natural fiber.

12. The plant-based leather substitute material of claim 1, wherein the textile substrate is a viscose textile substrate.

13. The plant-based leather substitute material of claim 1, wherein the plant-based leather substitute material is a woven or a knitted or a non woven material.

14. An item of clothing comprising at least a portion made from a fabric, the fabric being the plant-based leather substitute material of claim 1.

15. A protective garment, comprising:
at least one portion configured to be exposed to an external mechanical force; and
a reinforcement fabric disposed in the at least one portion configured to be exposed to the external mechanical force, the reinforcement fabric being made from the plant-based leather substitute material of claim 1.

16. A method of manufacturing a plant-based leather substitute material, the method comprising:
mixing a non-vulcanized natural rubber and a plant-based resin comprising castor seed oil to form a homogeneous mixture; and
dispensing the homogenous mixture onto a textile substrate to form a layer extending over the textile substrate;
wherein the textile substrate, the plant-based resin, and the non-vulcanized natural rubber are each free of animal products and derivatives of animal products.

17. The method of claim 16, wherein the layer has a thickness from about 0.1 mm to about 1.5 mm.

18. The method of claim 16, wherein the homogeneous mixture includes about 99% to about 60% of the plant-based resin and about 1% to about 40% of the non-vulcanized natural rubber.

19. The method of claim 18, wherein the ratio of the plant-based resin to the non-vulcanized natural rubber in the homogeneous mixture is about 90:10.

20. The method of claim 16, wherein the textile substrate and the layer collectively have an overall thickness of about 0.1 mm to about 1.5 mm.
